(19) United States
(12) Patent Application Publication
(10) Pub. No.: US 2013/0235278 A1
(43) Pub. Date: Sep. 12, 2013

(54) LIQUID CRYSTAL PANEL, LIQUID CRYSTAL DISPLAY DEVICE, TELEVISION DEVICE, AND METHOD OF MANUFACTURING LIQUID CRYSTAL PANEL

(71) Applicants: Shigeki Tanaka, Osaka-shi (JP); Nobufumi Tomimaru, Osaka-shi (JP); Makoto Kanbe, Osaka-shi (JP); Shunichi Takeuchi, Osaka-shi (JP); Taimi Oketani, Osaka-shi (JP)

(72) Inventors: Shigeki Tanaka, Osaka-shi (JP); Nobufumi Tomimaru, Osaka-shi (JP); Makoto Kanbe, Osaka-shi (JP); Shunichi Takeuchi, Osaka-shi (JP); Taimi Oketani, Osaka-shi (JP)

(73) Assignee: SHARP KABUSHIKI KAISHA, Osaka-shi, Osaka (JP)

(21) Appl. No.: 13/878,590

(22) PCT Filed: Oct. 7, 2011
(86) PCT No.: PCT/JP2011/073192

§ 371 Date: Apr. 10, 2013

(30) Foreign Application Priority Data
Oct. 14, 2010 (JP) 2010-231728

(51) Int. Cl. G02F 1/1335

(52) U.S. Cl. CPC G02F 1/133512
USPC 348/739; 349/110; 445/3

(57) ABSTRACT

A method of manufacturing a liquid crystal panel in which the bright point defect is effectively corrected is provided. The method of manufacturing a liquid crystal panel 11 including a pair of substrates 40 and 30, and a liquid crystal layer 50 provided between the pair of the substrates 40 and 30 includes detecting a bright point defect in the liquid crystal panel 11; forming a first light blocking portion BL1 in one of the substrates 40 and 30 and in a part of an area that surrounds the bright point defect with a plan view; forming a recess in a portion of one of the substrates 40, 30 that overlaps the bright point defect and on a surface of the one of the substrates 40 and 30 that is opposite from a surface facing the liquid crystal layer; and forming a second light blocking portion BL2 in the recess.

### TECHNICAL FIELD

The present invention relates to a liquid crystal panel, a liquid crystal display device, and a television device, and a method of manufacturing a liquid crystal panel.

### BACKGROUND ART

One of known methods of manufacturing a liquid crystal panel is described below. Switching components (e.g., TFTs) and pixel electrodes are arranged on one of a pair of glass substrates. Counter electrodes are arranged on the other one of the pair of glass substrates. Thereafter, the pair of glass substrates is bonded together with a spacer therebetween. Liquid crystals are injected between the glass substrates to form a liquid crystal layer. Then, polarizing plates are attached to respective outer surfaces of the glass substrates to obtain a liquid crystal panel.

Such a manufacturing process of a liquid crystal panel may include a test process that is executed at a predetermined timing for detecting errors. For example, the test process may be executed after the liquid crystal layer is formed, and in such a test process, a pair of test polarizing plates may be arranged to sandwich the glass substrates. Then, a test backlight is turned on to drive switching components. Accordingly, it is checked if any display failures or display errors occur.

If the liquid crystal layer includes a foreign obstacle, light that strikes the foreign obstacle may be irregularly reflected by the foreign obstacle in the test process. In such a case, a portion corresponding to the foreign obstacle may be detected as a bright point defect having high brightness even in case of displaying with black. The bright point defect extremely degrades the display quality and deteriorates the yield in production.

Patent Document 1 discloses a manufacturing method of a liquid crystal display device in which a bright point defect is corrected by a light blocking material. The liquid crystal panel in the Patent Document 1 includes a pair of glass substrates that seals a liquid crystal layer therebetween. In the manufacturing method, a recess is formed on at least one of the glass substrates. The recess is formed on a surface of the one glass substrate opposite from a surface facing the liquid crystal layer, and corresponding to a pixel in which the bright point defect occurs. Then, the recess is filled with a light blocking material. The light blocking material blocks light exiting from the bright point defective area, or blocks light exited from a backlight so that the light does not reach a foreign obstacle in the liquid crystal layer. Accordingly, the bright point defective area is displayed in black, and this corrects the bright point defect.

Patent Document 2 discloses a method of correcting a bright point defect in a display device by blackening pixels in which the bright point defect occurs. In the method, a laser irradiates a color filter corresponding to a pixel having the bright point defect. The laser irradiates the color filter from an outer surface of a glass substrate. Accordingly, a part of the color filter is decomposed and a space is formed therein. Next, a laser irradiates a black matrix arranged around effective pixels and this diffuses the black matrix into the space and blackens the space. Accordingly, the bright point defect area is displayed in black. This corrects the bright point defect.

### RELATED ART DOCUMENT

### Patent Document

Patent Document 1: Japanese Unexamined Patent Application Publication No. 05-210074
Patent Document 2: Japanese Unexamined Patent Application Publication No. 2006-227621

### Problem to be Solved by the Invention

With the method in Patent Document 1, if the point defect area is viewed from an angle, the light emitting from the bright point defect area may not be sufficiently blocked by the light blocking material and the light emitting from the bright point defect area may leak therefrom. With the method in Patent Document 2, a large amount of black matrix is required to correct the bright point defect area. Therefore, this method is not applicable to correct the bright point defect occurring in a large area. Namely, a size of correctable area is limited. This method also requires a long time to correct the bright point defect because it is difficult to diffuse the black matrix evenly into the space.

### Disclosure of the Present Invention

This invention was made in view of the above problems. An object of this invention is to provide a method of manufacturing a liquid crystal panel in which a bright point defect is effectively corrected. Another object of this invention is to provide a liquid crystal panel in which a bright point defect is effectively corrected.

### Means for Solving the Problem

Technologies described herein are related to a method of manufacturing a liquid crystal panel. The method of manufacturing a liquid crystal panel includes a pair of substrates and a liquid crystal layer provided between the pair of the substrates. The method includes the method comprising: detecting a bright point defect in the liquid crystal panel; forming a first light blocking portion in one of the substrates and in at least a part of a bright point defect area of the substrate, the bright point defect area surrounding the bright point defect with a plan view; forming a recess in a portion of one of the substrates so as to overlap the bright point defect, the recess being formed on a surface of the substrate that is opposite from a surface facing the liquid crystal layer; and forming a second light blocking portion in the recess.

According to the above method, the first light blocking portion is formed and accordingly, oblique rays of light exiting from the bright point defect area are less likely to leak therefrom. The second light blocking portion is formed and this blocks direct rays of light exiting from the bright point defect area that are recognized when viewed from the front of the bright point defect. The first light blocking portion and the second light blocking portion are formed and accordingly, the liquid crystal panel in which the bright point defect is effectively corrected is manufactured.

The first light blocking portion may be formed in a loop so as to surround the bright point defect with a plan view.

According to the above method, the oblique rays of light exiting from the bright point defect area are less likely to leak therefrom by the first light blocking portion. This achieves the liquid crystal panel in which the bright point defect is effectively corrected.

The first light blocking portion may be formed by blackening the part of the substrate.

The above method achieves the liquid crystal panel in which the light from the bright point defect area is effectively blocked by the first light blocking portion.

The part of the substrate may be blackened by diffusing a black matrix to the part of the substrate.

According to the above method, the part of the substrate is effectively blackened.

The part of the substrate may be blackened by irradiating the part of the substrate with a laser and carbonizing the part of the substrate.

According to the above method, the part of the substrate is effectively blackened.

The first light blocking portion may be only formed in a portion of the bright point defect area surrounding the bright point defect with a plan view, the portion overlapping one of a yellow pixel and a green pixel.

The bright point defect that occur in the portion overlapping one of the yellow pixel and the green pixel is easily recognized when viewed from the front side, whereas the bright point defect that occur in the portion overlapping one of the red pixel and the blue pixel is less likely to be recognized. Namely, the bright point defects that occur in the portion overlapping the red pixel and the blue pixel are unnoticeable without being corrected. According to the above method, the first light blocking portion is only formed in the portion overlapping one of the green pixel and the yellow pixel, and thus the first light blocking portion can be easily formed.

In forming the second light blocking potion, the second light blocking portion may be formed such that a part of the second light blocking portion and a part of the first light blocking portion overlap each other.

According to the above method, the oblique rays of light exiting from the bright point defect area are less likely to leak therefrom by the first and the second light blocking portions. This achieves the liquid crystal panel in which the bright point defect is effectively corrected.

In forming the second light blocking potion, the second light blocking portion may be formed by filling the recess with a light blocking material.

According to the above method, the second light blocking portion is effectively formed.

In forming the second light blocking potion, the light blocking material may be black lacquer.

According to the above method, the liquid crystal panel in which the light from the bright point defect area is effectively blocked by the second light blocking portion is manufactured.

In forming the second light blocking potion, the light blocking material may be filled into the recess so as to be flattened at an opening surface of the recess.

According to the above method, the liquid crystal panel in which the light from the bright point defect area is effectively blocked by the second light blocking portion is manufactured.

In forming the recess, the recess may be formed by drilling a part of the substrate using a drill.

According to the above method, the recess is effectively formed.

In forming the recess, the recess may be formed to have a depth greater than a half of a thickness of the substrate.

According to the above method, a light blocking property of the second light blocking portion that is formed in the recess is enhanced.

Another aspect of the technologies described herein relates to a liquid crystal panel including a pair of substrates, a liquid crystal layer, a first light blocking portion, a recess, and a second light blocking portion. The liquid crystal layer is provided between the pair of substrates. The first light blocking portion is formed in one of the substrates. The first light blocking portion is formed in apart of an area that surrounds a bright point defect of the substrate with a plan view. The recess is formed in a portion of one of the substrates that overlaps the bright point defect, and the recess is formed on a surface of the one substrate opposite from a surface facing the liquid crystal layer. The second light blocking portion is formed in the recess.

According to the above method, the first and second light blocking portions block light exiting from the bright point defect area. This achieves the liquid crystal panel in which the bright point defect is effectively corrected.

The technology disclosed herein is applicable to a liquid crystal display device including the above mentioned liquid crystal panel. A television device including the above liquid crystal display device is also available. The liquid crystal display device and the television device can achieve larger display areas with the above technology.

### Advantageous Effect of the Invention

According to the technology disclosed herein, a liquid crystal panel in which a bright point defect is corrected is manufactured. Further, a liquid crystal panel in which a bright point defect is corrected is achieved.

### BRIEF DESCRIPTION OF THE DRAWINGS

FIG. 1 is an exploded perspective view illustrating a general configuration of a television device TV according to a first embodiment of this invention.

FIG. 2 is an exploded perspective view of a liquid crystal display device 10.

FIG. 3 is a schematic cross-sectional view of the liquid crystal display device 10.

FIG. 4 is a magnified cross-sectional view of a test liquid crystal panel 11a before a bright point defect is corrected.

FIG. 5 is a cross-sectional view of the test liquid crystal panel 11a during a process of detecting a bright point defect in the test liquid crystal panel 11a.

FIG. 6 is a magnified cross-sectional view illustrating a part of a liquid crystal panel 11 during a process (1) of manufacturing the liquid crystal panel 11.

FIG. 7 is a plan view illustrating a part of the liquid crystal panel 11 during the process (1) of manufacturing the liquid crystal panel 11.

FIG. 8 is a magnified cross-sectional view illustrating a part of the liquid crystal panel 11 during a process (2) of manufacturing the liquid crystal panel 11.

FIG. 9 is a plan view illustrating a part of the liquid crystal panel 11 during the process (2) of manufacturing the liquid crystal panel 11.

FIG. 10 is a magnified cross-sectional view illustrating a part of the liquid crystal panel 11 during a process (3) of manufacturing the liquid crystal panel 11.

FIG. 11 is a magnified cross-sectional view illustrating a part of the liquid crystal panel 11 during a process (4) of manufacturing the liquid crystal panel 11.

FIG. 12 is a plan view illustrating a part of the liquid crystal panel 11 during the process (4) of manufacturing the liquid crystal panel 11.

FIG. 13 is a magnified cross-sectional view of the liquid crystal panel 11.

FIG. 14 is a magnified cross-sectional view illustrating a part of a liquid crystal panel 111 during a process (1) of manufacturing the liquid crystal panel 111 according to a second embodiment.

FIG. 15 is a plan view illustrating a part of the liquid crystal panel 111 during the process (1) of manufacturing the liquid crystal panel 111 according to the second embodiment.

FIG. 16 is a magnified cross-sectional view illustrating a part of a liquid crystal panel 211 according to a third embodiment.

FIG. 17 is a plan view illustrating a part of ea liquid crystal panel during a process (1) of manufacturing a liquid crystal panel according to a fourth embodiment.

FIG. 18 is a plan view illustrating a part of the liquid crystal panel during a process (2) of manufacturing the liquid crystal panel according to the fourth embodiment.

FIG. 19 is a plan view illustrating a part of a liquid crystal panel during a process (1) of manufacturing a liquid crystal panel according to a fifth embodiment.

FIG. 20 is a plan view illustrating a part of the liquid crystal panel during a process (2) of manufacturing the liquid crystal panel according to the fifth embodiment.

### MODE FOR CARRYING OUT THE INVENTION

### First Embodiment

A first embodiment will be described with reference to the drawings. An X-axis, a Y-axis, and a Z-axis are illustrated in a part of each drawing. Directions indicated by the axes in each drawing correspond to directions indicated by the respective axes in other drawings. A Y-axis direction corresponds to a vertical direction and an X-axis direction corresponds to a horizontal direction.

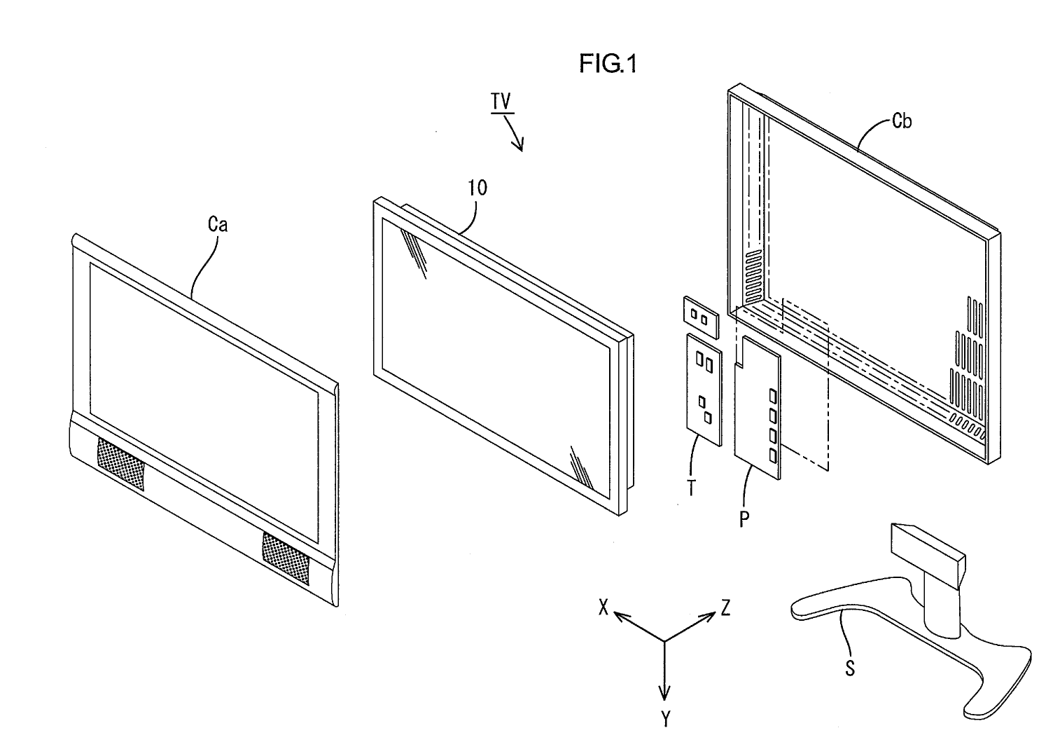

FIG. 1 illustrates a television device TV according to the first embodiment in an exploded perspective view. As illustrated in FIG. 1, the television device TV includes a liquid crystal display 10, front and back cabinets Ca and Cb which house the liquid crystal display device 10 therebetween, a power supply P, a tuner T, and a stand S. The liquid crystal display device 10 has a landscape rectangular shape as a whole and held in the vertical position.

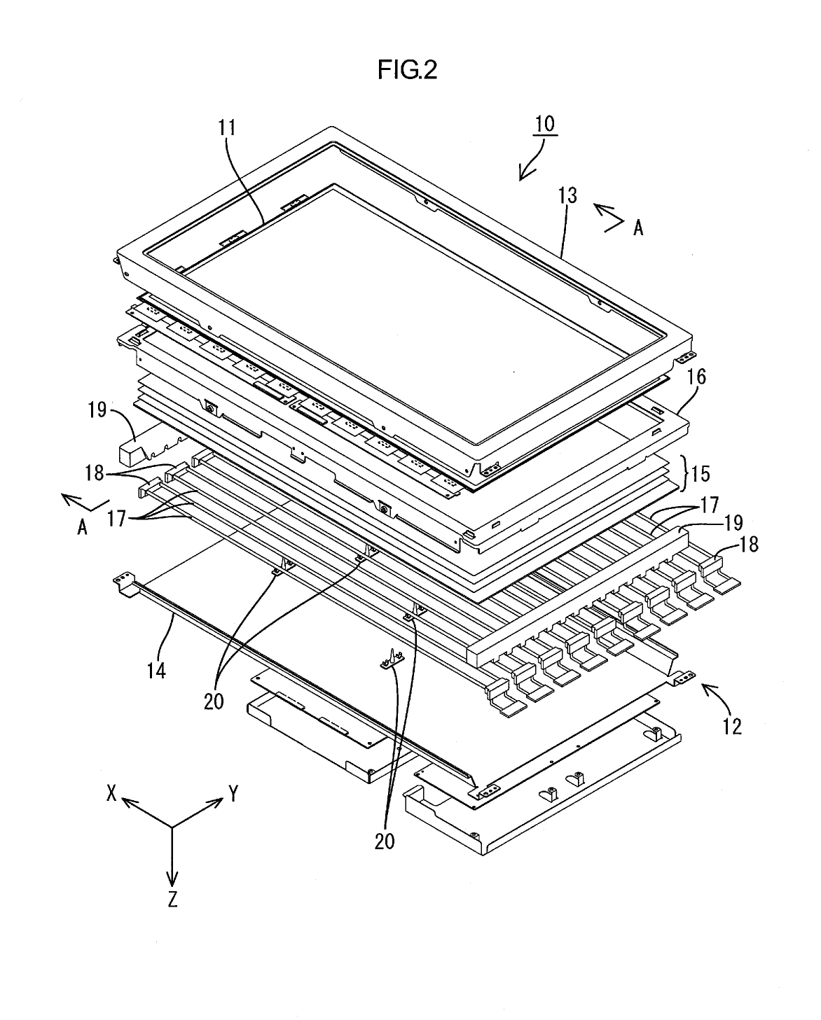

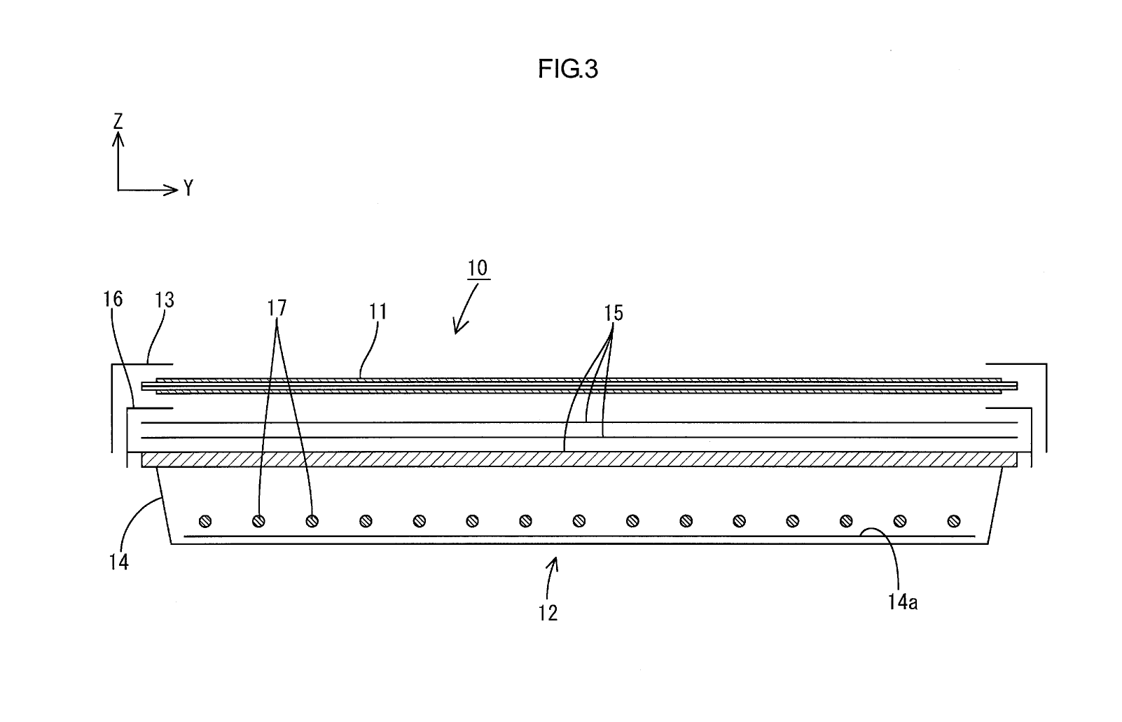

FIG. 2 illustrates the liquid crystal display device 10 in an exploded perspective view. FIG. 3 illustrates the liquid crystal display device 10 in a schematic cross-sectional view taken along the Y-axis direction. An upper side in each of FIG. 2 and FIG. 3 corresponds to a front side, and a lower side therein corresponds to a rear side. As illustrated in FIG. 2 and FIG. 3, the liquid crystal display device 10 includes a liquid crystal panel 11 as a display panel, and a backlight unit 12 as an external light source. A frame-shaped bezel 13 integrally holds the liquid crystal panel 11 and the backlight unit 12. The backlight unit 12 is a direct type backlight unit, and includes a plurality of light sources (cold cathode tubes 17, which are high-pressure discharge tubes, are used in the embodiment). The light sources are arranged behind and along a panel surface (i.e., display surface) of the liquid crystal panel 11. The liquid crystal panel 11 will be explained later.

As illustrated in FIG. 2 and FIG. 3, the backlight unit 12 includes a chassis 14, an optical member 15, and a frame 16. The chassis 14 is made of metal such as aluminum. The chassis 14 has a box-like shape having an opening on its upper side. The optical member 15 is arranged on the backlight chassis 14 so as to cover the opening thereof. The frame 16 has a frame-like shape and holds the optical member 15.

The chassis 14 houses a plurality of cold cathode tubes 17, holders 18, lamp holders 19, lamp clips 20, and a reflection sheet 14a. The reflection sheet 14a is illustrated in FIG. 3, and not illustrated in FIG. 2. Each of the cold cathode tubes 17 has an elongated tubular shape. Each of the plurality of cold cathode tubes 17 (eighteen cold cathode tubes 17 in total in FIG. 2) is housed in the chassis 14 such that a longitudinal direction (i.e., axial direction) thereof matches a longitudinal direction of the chassis 14. The holders 18 are made of rubber. The holders 18 hold ends of the cold cathode tubes 17. The lamp holders 19 cover a group of the cold cathode tubes 17 and a group of the holders 18. Each of the lamp clips 20 is made of a synthetic resin, and has a clip-like shape. The lamp clips 20 fix the cold cathode tubes 17 to the chassis 14. The reflection sheet 14a is made of a resin sheet having light reflectivity. The reflection sheet 14a is arranged along an inner surface of the chassis 14. The reflection sheet 14a reflects light emitted from the cold cathode tubes 17 toward an optical member 15 side (light exit side). In the backlight unit 12, a light exit side of the backlight unit 12 is a side closer to the optical member 15 than the cold cathode tubes 17.

The optical member 15 is made of a synthetic resin having a light blocking property, and has a plan-view rectangular shape. The optical member 15 is arranged between the cold cathode tubes 17 and the liquid crystal panel 11. The optical member 15 may include a diffuser plate, a diffuser sheet, a lens sheet, and a brightness enhancing sheet in this sequence from the rear side. The optical member 15 converts liner light emitted from the cold cathode tubes 17 into uniform planar light.

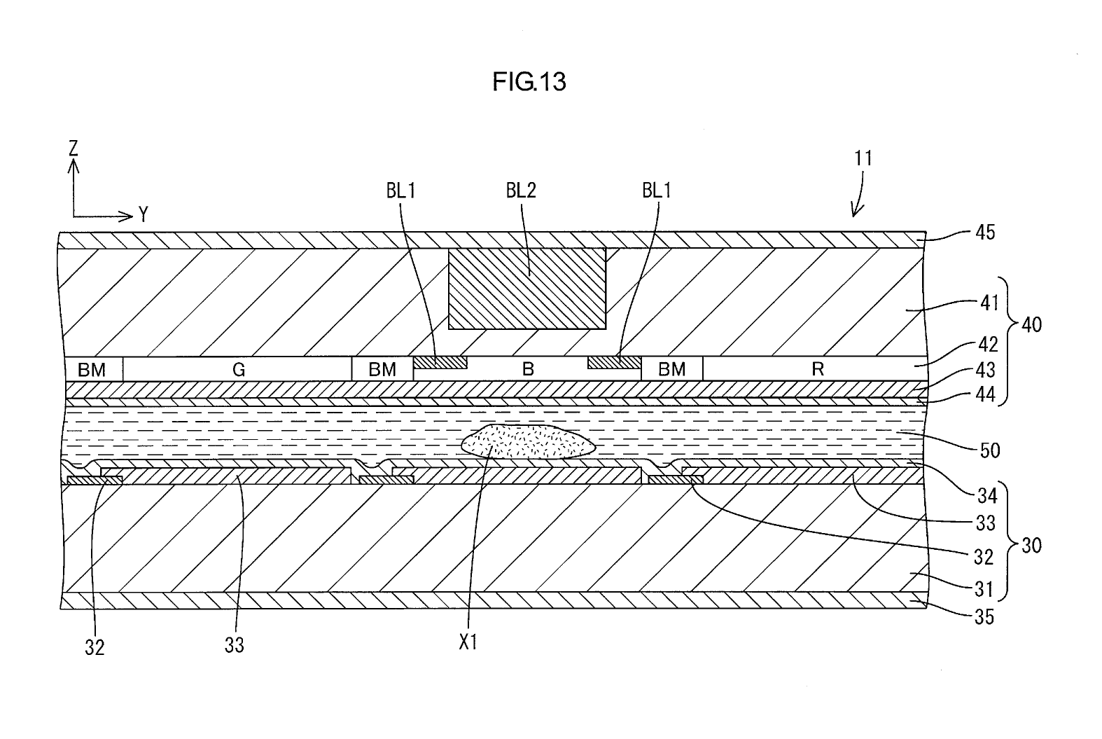

Next, the liquid crystal panel 11 will be explained. FIG. 13 illustrates a magnified cross-sectional view of the liquid crystal panel 11. The liquid crystal panel 11, as illustrated in FIG. 13, includes a pair of boards 30 and 40. The pair of boards 30 and 40 is bonded together with a predetermined gap therebetween. Liquid crystals are sealed between the boards 30 and 40, forming a liquid crystal layer 50.

The board 30 includes a glass substrate 31, TFTs (Thin Film Transistor) 32, pixel electrodes 33, and an alignment film 34. The TFTs 32 are semiconductor components and arranged on a side of the glass substrate 31 close to the liquid crystal layer 50. The pixel electrodes 33 are electrically connected to the TFTs 32. The alignment film 34 is arranged on a side of the TFTs 32 and the pixel electrodes 33 close to the liquid crystal layer 50. The board 30 (or the glass substrate 31) of the pair of boards 30 and 40 is arranged adjacent to the backlight unit 12.

The board 40 is an opposing board including a glass substrate 41, color filter 42, counter electrodes 43, and an alignment film 44. The color filter 42 is arranged on a side of the glass substrate 41 close to the liquid crystal layer 50. The color filter 42 has colored sections such as R (red), G (green), B (blue) sections (an example of picture elements) arranged in a predetermined pattern. A black matrix BM is arranged between the colored sections. The counter electrodes 43 are arranged on a side of the color filter 42 close to the liquid crystal layer 50. The alignment film 44 is arranged on a side of the counter electrodes 43 facing the liquid crystal layer 50. A polarizing plate 45 is provided on a side of the glass substrate 41 away from the liquid crystal layer 50.

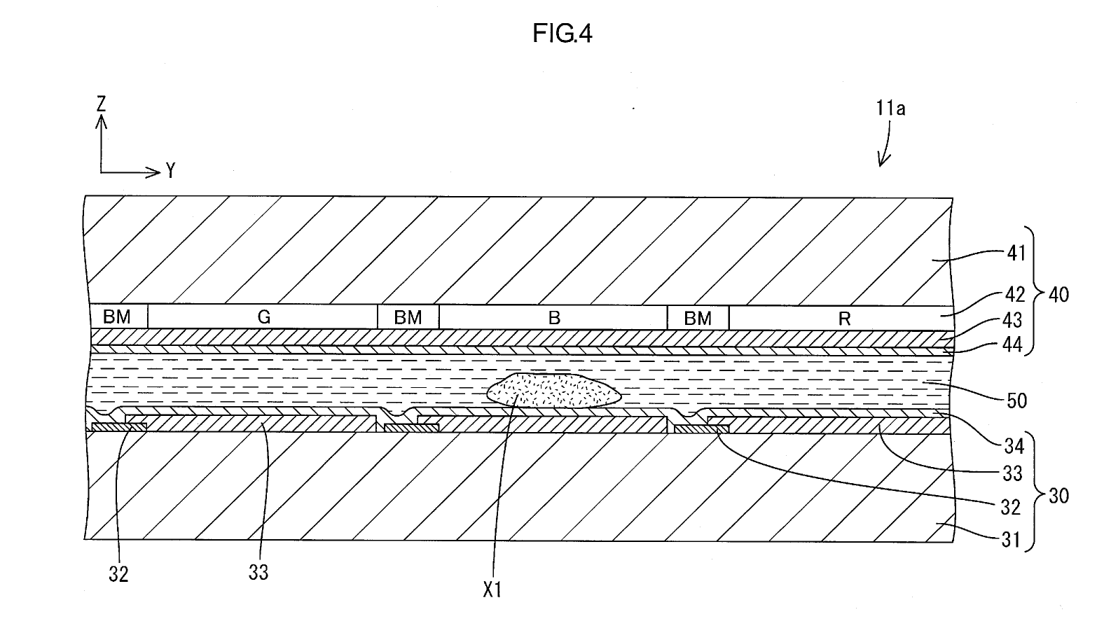

The liquid crystal panel 11 in FIG. 13 includes a foreign obstacle X1, which may cause a bright point defect, in the liquid crystal layer 50. The liquid crystal panel 11 also includes a light blocking means for blocking light exiting from a portion of the liquid crystal layer 50 including the foreign obstacle X1. Thus, the bright point defect is corrected in the liquid crystal panel 11. In the present embodiment, the foreign obstacle X1 is included in a portion of the liquid crystal layer 50 overlapping the colored section B (blue) of the color filter 42 in FIG. 4 (hereinafter, referred to as a colored section B to be corrected).

The light blocking means for blocking light exiting from a portion of the liquid crystal layer 50 including the foreign obstacle X1 will be explained. The light blocking means is provided in the liquid crystal panel 11. A first light blocking portion BL1 is formed in apart of the color filter 42 in the liquid crystal panel 11 to surround the foreign obstacle X1 in a loop shape with a plan view. The first light blocking portion BL1 is black and blocks light. A second light blocking portion BL2 is formed in a part of the glass substrate that is provided on the front side (light exit side) of the liquid crystal panel 11. The second light blocking portion BL2 overlaps the foreign obstacle X1 with a plan view. The second light blocking portion BL2 is also black and blocks light. The first light blocking portion BL1 blocks rays of light that causes a bright point defect due to the foreign obstacle X1. Thus, the bright point defect is not recognized when the area overlapping the foreign obstacle X1 is viewed from the front side (light exit side) of the liquid crystal panel 11. Further, the first light blocking portion BL1 blocks oblique rays of light that causes the bright point defect due to the foreign obstacle X1. Thus, the bright point defect is not recognized when the area overlapping the foreign obstacle X1 is viewed from an angled front side (light exit side) of the liquid crystal panel 11. Accordingly, the light reflecting off the foreign obstacle X1 is effectively blocked in the area of the liquid crystal panel 11 where the foreign obstacle X1 exists. The following will describe the method of manufacturing the liquid crystal panel 11 in which the bright point defect is corrected.

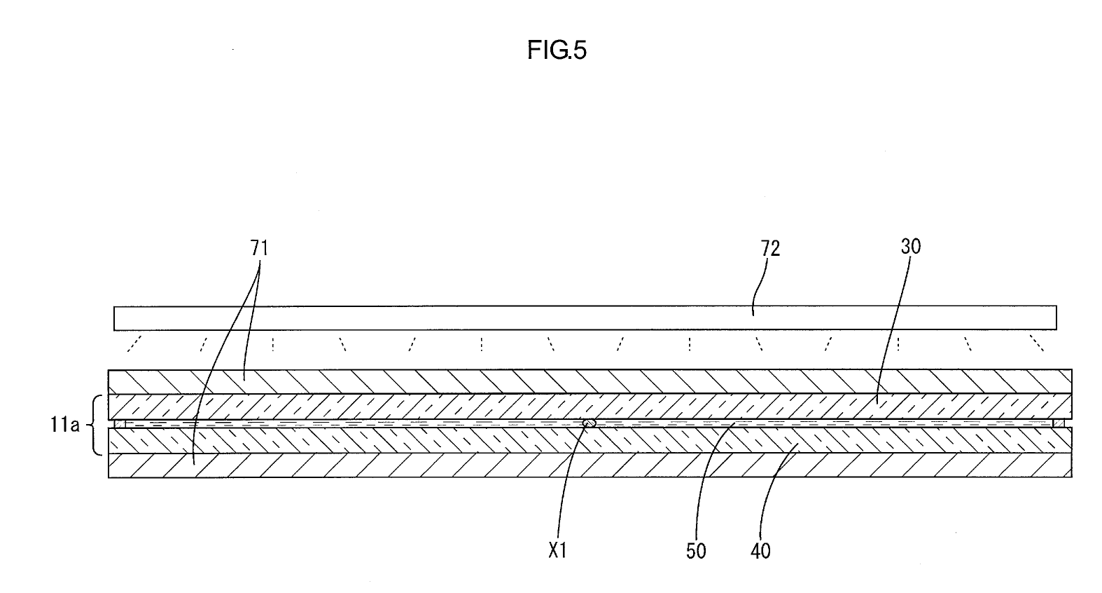

First, to detect a portion in which a bright point defect is caused, a process for detecting a bright point defect is performed. A liquid crystal panel in a manufacturing process is referred to as a test liquid crystal panel 11a hereinafter. FIG. 4 is a magnified cross-sectional view of the test liquid crystal panel 11a before correcting the bright point defect. FIG. 5 is a cross-sectional view of the test liquid crystal panel 11a during a process for detecting a bright point defect in the test liquid crystal panel 11a. The test liquid crystal panel 11a in FIG. 4 does not include polarizing plates 35, 45. The test liquid crystal panel 11a is a liquid crystal panel before the polarizing plates 35, 45 are arranged on surfaces of the glass substrates 31, 41. Namely, the surfaces of the glass substrates 31, 41 are exposed during the detecting process.

In the detecting process, a pair of test polarizing plates 71 are arranged to sandwich the boards 30 and 40 of the test liquid crystal panel 11a therebetween. Then, as illustrated in FIG. 5, a test backlight 72 is arranged on a rear side of the test liquid crystal panel 11a, and turned on. The test liquid crystal panel 11a is illuminated with light from the test backlight 72 from the rear side thereof. Wirings arranged on the glass substrate 31 are connected to a test circuit and signals are supplied to each of the wirings from the test circuit to drive the TFTs 32. Accordingly, the alignment of the liquid crystals included in the liquid crystal layer 50 is controlled to provide a display condition on the test liquid crystal panel 11a. The display condition is checked by image processing or checked visually by an inspector.

In the detection process, a bright point defect that is recognized as a bright dot on a black display may be detected. The foreign obstacle X1 in the liquid crystal layer 50 irregularly reflects light and this may cause the bright point defect. If such a bright point defect is detected, the bright point defect is corrected through a series of processes for correcting the bright point defect. The processes will be explained later. Possible causes of entrance of the foreign obstacle X1 in the liquid crystal layer 50 are as follows. The foreign obstacle X1 may be adhered to surfaces of the boards 30 and 40 facing the liquid crystal layer 50 before providing the liquid crystals in the space between the boards 30 and 40. The foreign obstacle X1 may be included in the liquid crystals.

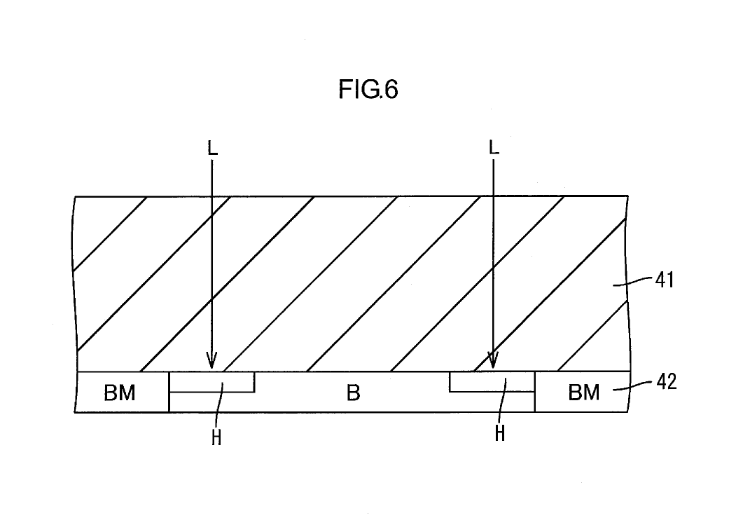

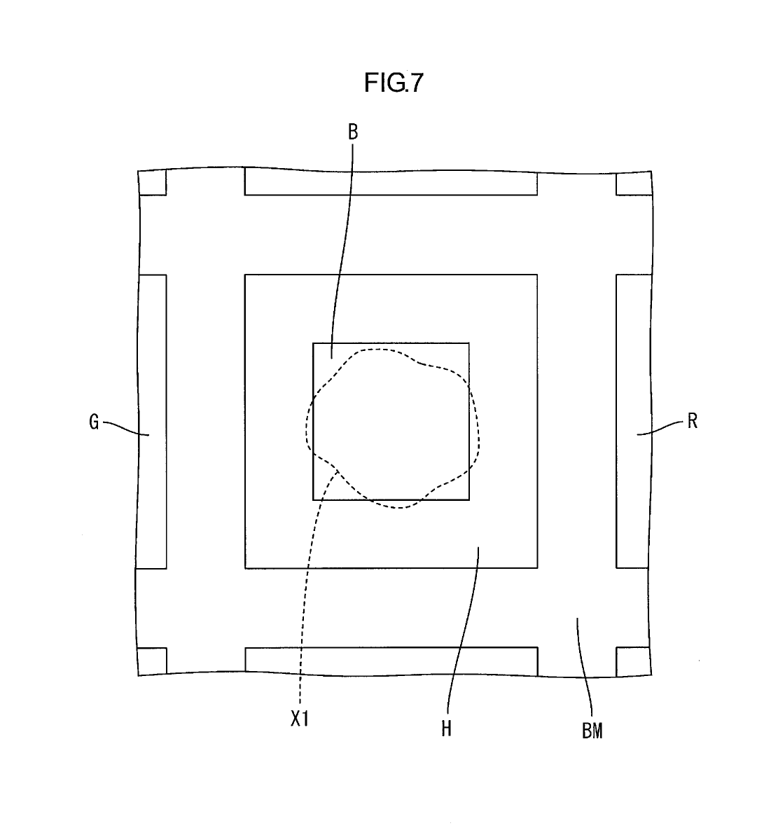

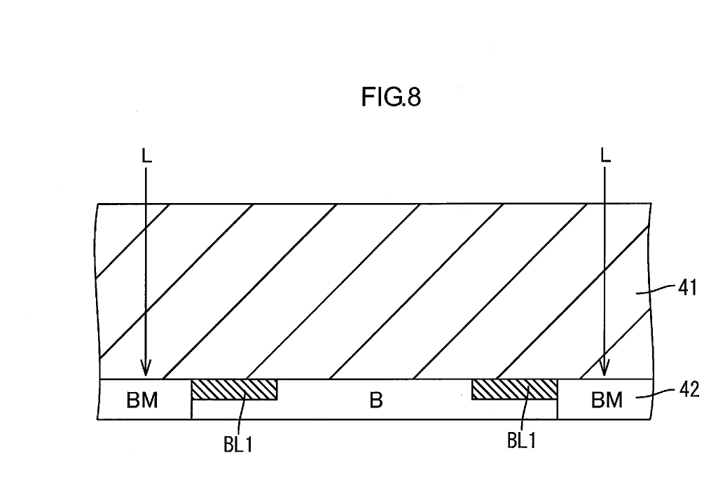

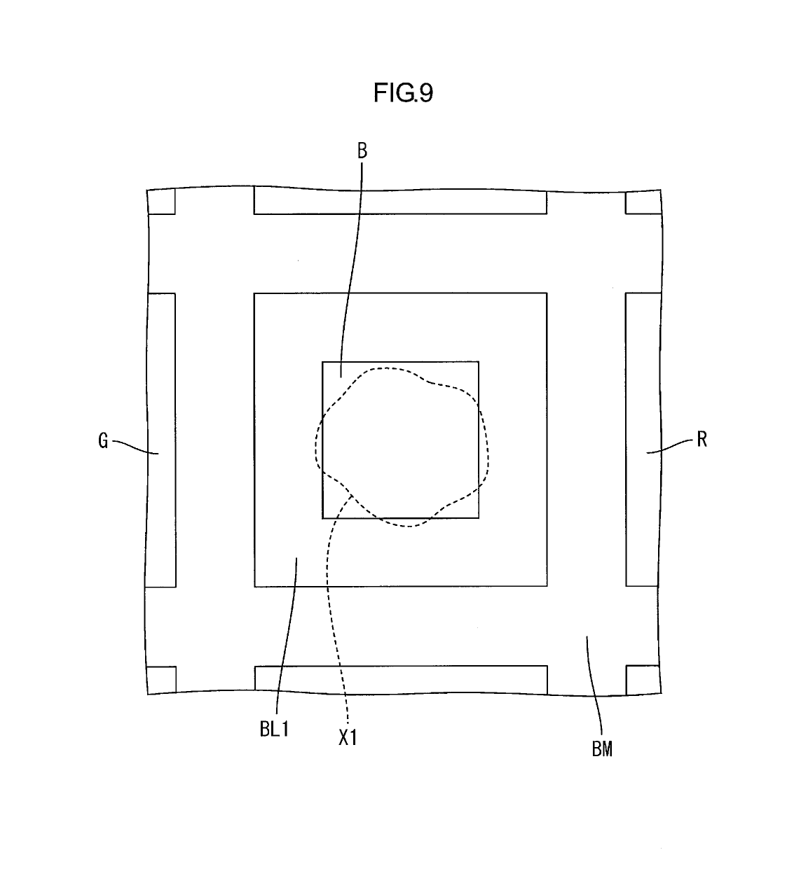

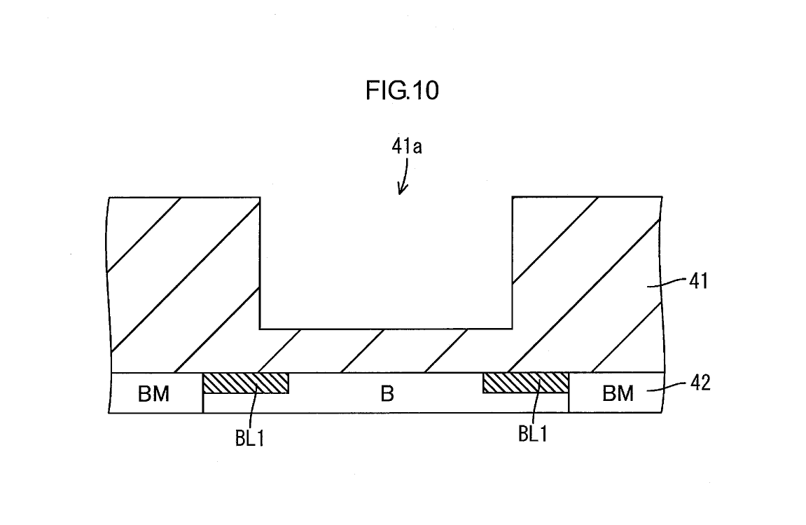

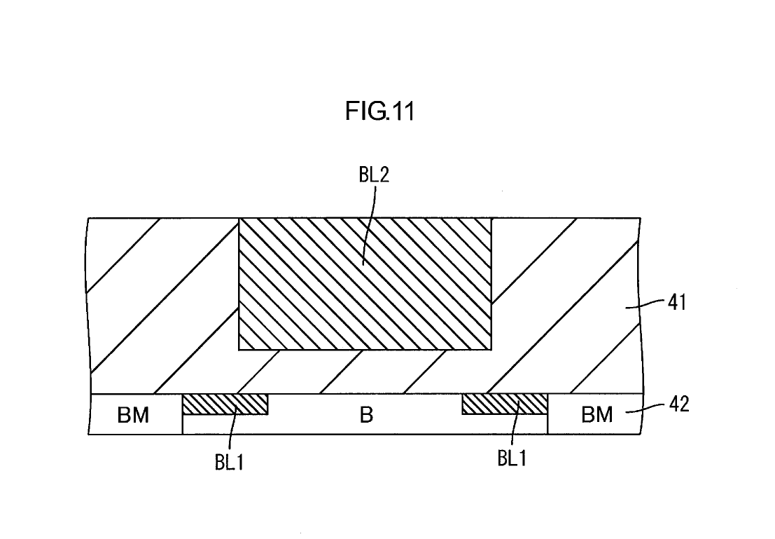

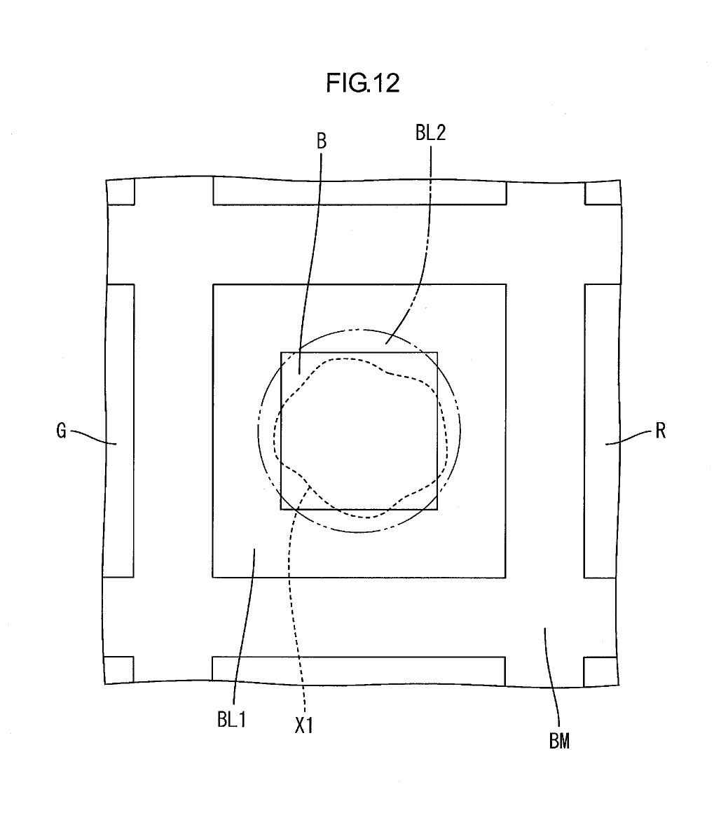

FIG. 6 to FIG. 12 illustrate a process of correcting the bright point defect, namely, a process of manufacturing the liquid crystal panel 11 in which the bright point defect is corrected. FIG. 6, FIG. 8, FIG. 10, and FIG. 11 are cross-sectional views each illustrating a portion of the glass substrate 41 and the color filter 42 adjacent to the colored section B to be corrected. The glass substrate 41 is provided on the front side (light exit side) of the liquid crystal panel 11. FIG. 7, FIG. 9, and FIG. 12 are plan views seen from the front side each illustrating a portion of the color filter 42 adjacent to the colored section B to be corrected.

The bright point defect correcting process includes a first light blocking portion forming process, a recess forming process, and a second light blocking portion forming process. As illustrated in FIG. 6, in the first light blocking portion forming process, a portion of a surface of the colored section B to be corrected in the color filter 42 is irradiated with a laser from the front side of the glass substrate 41. Herein, the laser irradiates a portion of the colored section B to be corrected along the black matrix BM that is formed around the colored section B to be corrected. Accordingly, a trace of laser irradiation is formed in a loop inside and adjacent to the black matrix BM. The part of the colored section B to be corrected that is irradiated with laser is decomposed and this forms a hole H that is a space. The hole H is formed in a loop and inside the black matrix BM that surrounds the colored section B to be corrected in the color filter 42, as illustrated in FIG. 7. Strength of the laser is adjusted not to cause denaturalization in the color filter 42 by changing electric power and pulse frequency.

Next, a laser irradiates the black matrix BM adjacent to and outside the hole H as illustrated in FIG. 8. This diffuses the black matrix BM into the hole H and fills the hole H with the black matrix BM. The hole H filled with the black matrix BM becomes black. This forms the first light blocking portion BL1 that blocks light. As illustrated in FIG. 9, the first light blocking portion BL1 is formed in a loop and inside the black matrix MB that surrounds the colored section B to be corrected in the color filter 42. A series of processes illustrated in FIG. 7 and FIG. 9 is performed by laser irradiation from an inner edge side of the loop-shaped hole H toward a black matrix BM side. In the laser irradiation method, the hole H is formed by moving laser, and if the laser reaches the black matrix BM, the black matrix BM is diffused into the hole H.

Next, the recess forming process is performed. As illustrated in FIG. 10, in the recess forming process, a recess 41a having a substantially cylindrical shape is formed in a part of the glass substrate 41 that overlaps the foreign obstacle X1. The glass substrate 41 is provided on the front side of the liquid crystal panel 11 and the recess 41a is formed on a surface of the glass substrates 41 that is opposite to the liquid crystal layer 50 side surface. The recess 41a is formed by drilling the glass substrate 41 with a micro drilling device. The recess 41a is formed to have a depth that is greater than a half of a thickness of the glass substrate 41 and so as not to be close to the color filter 42 to maintain the strength of the glass substrate 41. The recess 41a is formed such that an outer periphery of a bottom surface of the recess 41 overlaps apart of the first light blocking portion BL1 with a plan view.

Next, the second light blocking portion forming process is performed. In the second light blocking portion forming process, as illustrated in FIG. 11, black lacquer is filled into the recess 41a that is formed by the recess forming process. The filling process may be performed by coating the surface of the glass substrate 41 having the recess 41a with the black lacquer. Accordingly, the second light blocking portion BL2 that blocks light is formed inside the recess 41a. The black lacquer coats and fills the recess 41a such that a surface of the filled black lacquer is flat at an opening of the recess 41a. As illustrated in FIG. 12, the second light blocking portion BL2 that is formed by filing the recess 41a with black lacquer overlaps almost an entire area of the colored portion B to be corrected in the color filter 42 and also overlaps a part of the first light blocking portion BL1 with a plan view. The second light blocking portion BL2 is formed in substantially a circular shape inside the first light blocking portion BL1 so as to overlap an entire projection area of the foreign obstacle X1.

After forming the light blocking portion BL2, the polarizing plate 35 is arranged on a surface of the glass substrate 35 that is opposite from the liquid crystal layer 50 side surface. The polarizing plate 45 is arranged on a surface of the glass substrate 41 that is opposite from the liquid crystal layer 50 side. The liquid crystal panel 11 in which the bright point defect is corrected as illustrated in FIG. 13 is manufactured by the above-mentioned processes. According to the method in the present embodiment, the liquid crystal panel 11 in which the point defect is effectively corrected by the first light blocking portion BL1 and the second light blocking portion BL2 is obtained.

According to the method of manufacturing the liquid crystal panel 11 of the present embodiment, the first light blocking portion BL1 is formed in the first light blocking portion forming process, and accordingly oblique rays of light exiting from the bright point defect area are less likely to leak. Also, the second light blocking portion BL2 that is formed in the second light blocking portion forming process can block direct rays of light exiting from the bright point defect area that are recognized when viewed from the front of the bright point defect. By executing the first and second light blocking portion forming processes, the liquid crystal panel 11 in which the bright point defect is effectively corrected can be obtained.

In the recess forming process, the recess is not allowed to have a depth that reaches a portion of the glass substrate 41 close to the liquid crystal layer and also it is difficult to form the recess having a large opening, because it is required to maintain the strength of the glass substrate and surface visibility of the glass substrate. Therefore, the light blocking portion BL2 cannot block all of the light that is caused by the foreign obstacle X1. Thus, oblique rays of light exiting from the bright point defect may leak from the bright point defect area. The method of manufacturing the liquid crystal panel 11 according to the present embodiment provides the first light blocking portion BL1 as well as the second light blocking portion BL2. Accordingly, the oblique rays of light exiting from the bright point defect are less likely to leak from the bright point defect area. Thus, a large bright point defect can be corrected.

In the first light blocking portion forming process for diffusing the black matrix BM into the hole H, it is difficult to diffuse the black matrix BM uniformly in the entire hole H. Further, if the hole H is large, a large amount of black matrix BM is required to fill in the hole H, and therefore, the entire hole may not be filled with the black matrix BM. It is also difficult to optimize irradiation conditions of the laser for diffusing the black matrix BM. Therefore, it is difficult to form the light blocking portion BL1 so as to cover the area that entirely overlaps the foreign obstacle X1. Thus, it is difficult for the light blocking portion BL1 to block the direct rays of light that are recognized when viewed from the front of the bright point defect. According to the method of manufacturing the liquid crystal panel 11 of the present embodiment, the second light blocking portion BL2 is formed as well as the first light blocking portion BL1. With this configuration, the direct rays of light that are recognized when viewed from the front of the bright point defect are blocked. Thus, a large bright point defect can be corrected. Further, the hole H is formed in only the portion of the colored section to be corrected that is inside and adjacent to the black matrix BM. This shortens the time for diffusing the black matrix BM to the hole H in the first light blocking portion forming process. Namely, this also shortens the manufacturing time for the liquid crystal panel 11.

In the method of manufacturing the liquid crystal panel 11 according to the present embodiment, the first light blocking portion BL1 is formed in a loop so as to surround the bright point defect with a plan view in the first light blocking portion forming process. The oblique rays of light exiting from the bright point defect are less likely to leak from the bright point defect area by the first light blocking portion BL1. Thus, the liquid crystal panel 11 in which the bright point defect is effectively corrected is obtained.

According to the method of manufacturing the liquid crystal panel 11 of the present embodiment, the first light blocking portion BL1 is formed by blackening a part of the color filter 42 in the first light blocking portion forming process. Accordingly, the liquid crystal panel 11 in which the light exiting from the bright point defect is effectively blocked by the first light blocking portion BL1 is obtained.

According to the method of manufacturing the liquid crystal panel 11 of the present embodiment, the black matrix BM is diffused to a part of the color filter 42 to blacken the part of the color filter 42 in the first light blocking portion forming process. Thus, the part of the color filter 42 is effectively blackened in the first light blocking portion forming process.

In the method of manufacturing the liquid crystal panel 11 according to the present embodiment, the second light blocking portion BL2 is formed such that apart of the second light blocking portion BL2 and a part of the first light blocking portion BL1 overlap in the second light blocking portion forming process. The first light blocking portion BL1 and the second light blocking portion BL2 block the light exiting from the bright point defect area and the oblique rays of light are less likely to leak from the bright point defect area. This achieves the liquid crystal panel 11 in which the bright point defect is corrected more effectively.

In the method of manufacturing the liquid crystal panel 11 according to the present embodiment, the second light blocking portion BL2 is formed by filling the recess 41a with the light blocking material in the second light blocking portion forming process. According to the method, the second light blocking portion BL2 is effectively formed in the second light blocking portion forming process.

In the method of manufacturing the liquid crystal panel 11 according to the present embodiment, the black lacquer is used as the light blocking material in the second light blocking portion forming process. This achieves the liquid crystal panel 11 in which the light exiting from the bright point defect area is effectively blocked by the second light blocking portion BL2.

In the method of manufacturing the liquid crystal panel 11 according to the present embodiment, the recess 41a is filled with the black lacquer that is used as a light blocking material such that a surface of the black lacquer is flat at an opening surface of the recess 41a in the second light blocking portion forming process. This achieves the liquid crystal panel 11 in which the light causing the bright point defect is effectively blocked by the second light blocking portion BL2.

In the method of manufacturing the liquid crystal panel 11 according to the present embodiment, the recess 41a is formed by drilling the glass substrate 41 with a micro drilling device in the recess forming process. Thus, the glass substrate is easily drilled and the recess 41a is effectively formed in the recess forming process.

In the method of manufacturing the liquid crystal panel 11 according to the present embodiment, the recess 41a is formed to have a depth that is greater than a half of a thickness of the glass substrate 41 in the recess forming process. Therefore, the second light blocking portion BL2 occupies a large area in the part of the glass substrate 41 that overlaps the foreign obstacle X1 with a plan view. This improves the light blocking effect of the second light blocking portion BL2 formed in the recess 41a in the second blocking portion forming process.

In the method of manufacturing the liquid crystal panel 11 according to the present embodiment, the first light blocking portion BL1 and the second light blocking portion BL2 block light that may cause the bright point defect. This achieves the liquid crystal panel 11 in which the bright point defect is effectively corrected.

### Second Embodiment

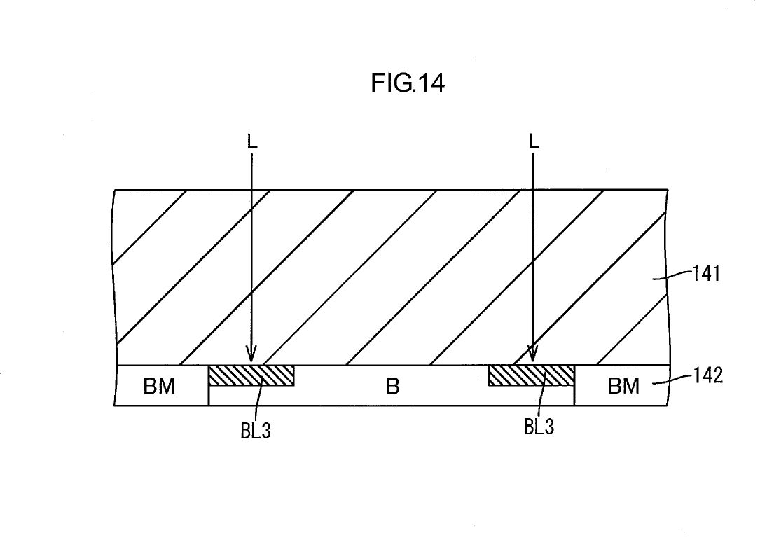

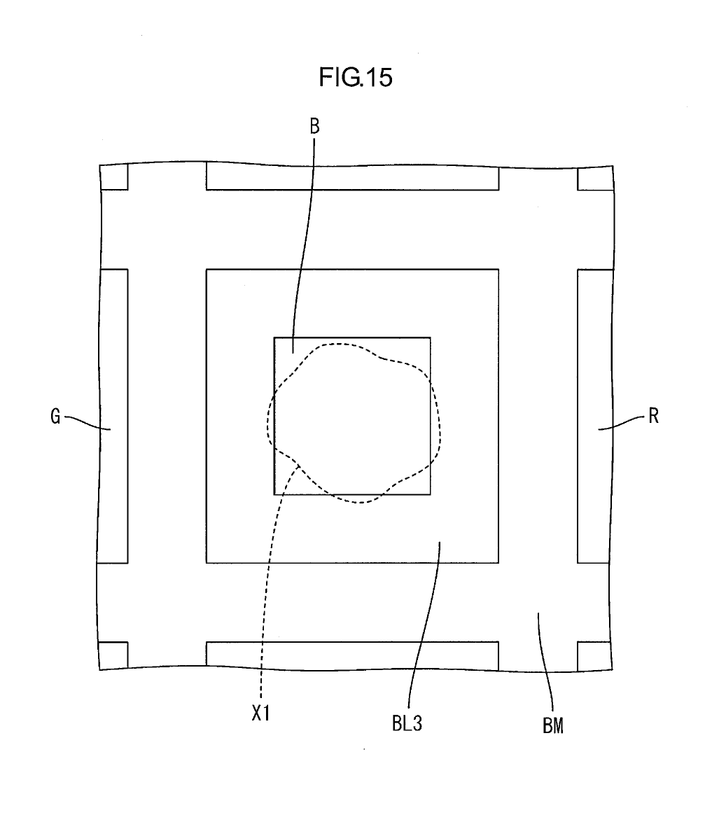

A second embodiment will be described with reference to the drawings. FIG. 14 is a cross-sectional view illustrating a portion of a glass substrate 141 provided on the front side (light exit side) of the liquid crystal panel and a portion of a color filter 142, and the portions are adjacent to the colored section B to be corrected. FIG. 15 is a plan view of a portion of the color filter 142 adjacent to the colored section B to be corrected seen from the front. The second embodiment differs from the first embodiment in the method of blackening a part of the color filter 142 in the light blocking portion forming process. Other structures are same as those of the first embodiment, and thus configurations, functions, and effects similar to those of the first embodiment will not be explained. In FIG. 14 and FIG. 15, portions indicated by the number obtained by adding 100 to the reference numerals in FIG. 8 and FIG. 9 are same as the portions explained in the first embodiment.

In the method of manufacturing the liquid crystal panel according to the second embodiment, apart of the color filter 142 is carbonized to be blackened in the first light blocking portion forming process. Specifically, a direct method may be used to form a first blocking portion B3 as illustrated in FIG. 14. In the direct method, a laser irradiates the part of the colored section B of the color filter 142 to be corrected from the front side of the glass substrate 141. The irradiated part of the color filter 142 is burned to be blackened. This forms the first light blocking portion BL3. A laser irradiates a portion of the colored section B to be corrected along the black matrix BM that is formed around the colored section B to be corrected. Accordingly, a trace of laser irradiation is formed in a loop inside and adjacent to the black matrix BM. In the direct method, the intensity of laser is smaller than that of laser used for forming the hole H in the first light blocking portion forming process of the first embodiment. Thus, laser energy required for the direct method is smaller than that for forming the hole H in the color filter in the first light blocking portion forming process of the first embodiment. As illustrated in FIG. 15, the first light blocking portion BL3 is formed in a loop inside the black matrix BM that surrounds the colored section B of the color filter 42 to be corrected with a plan view. In the method of manufacturing the liquid crystal panel according to the second embodiment, the first light blocking portion BL3 formed as described above and accordingly, a part of the color filter 142 is directly blackened without forming the hole H in the first light blocking portion forming process. Thus, a part of the color filter 142 is effectively blackened in the first light blocking portion forming process.

### Third Embodiment

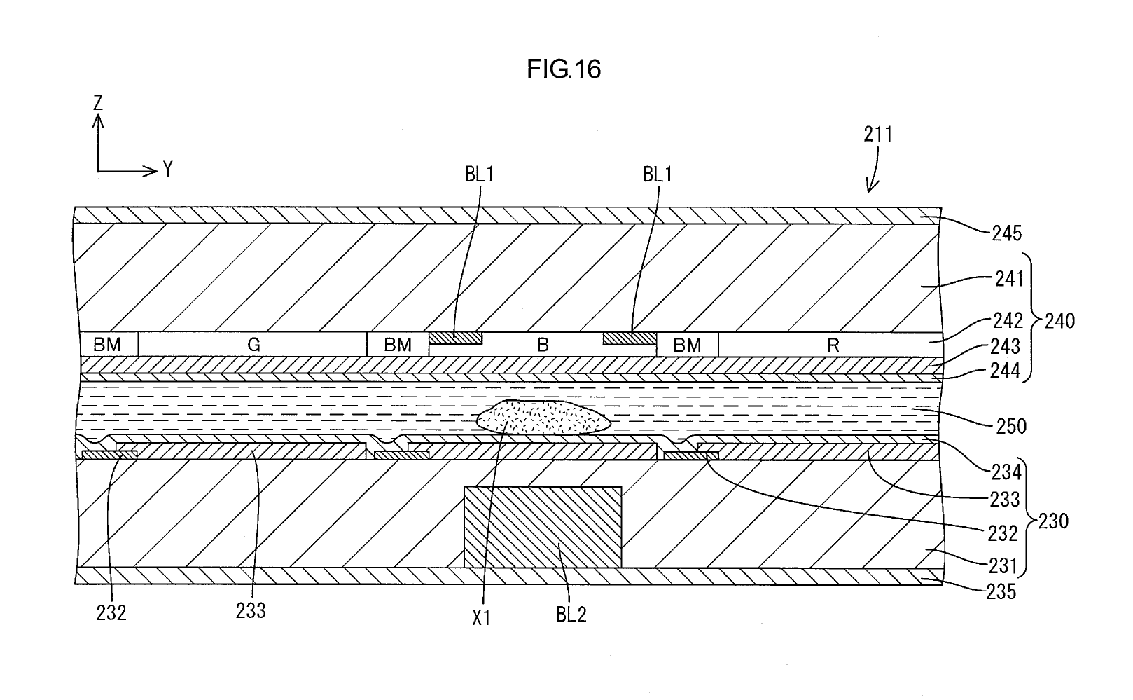

A third embodiment will be described with reference to the drawings. FIG. 16 is a magnified cross-sectional view of a liquid crystal panel 211 according to the third embodiment. The second embodiment differs from the first embodiment in the position of the second light blocking portion BL2. Other structures are same as those of the first embodiment, and thus configurations, functions, and effects similar to those of the first embodiment will not be explained. In FIG. 16, portions indicated by the number obtained by adding 200 to the reference numerals in FIG. 13 are same as the portions explained in the first embodiment.

In the liquid crystal panel 211 according to the third embodiment, the second light blocking portion BL2 is formed in the glass substrate 41 that is on the rear side. The second light blocking portion BL2 is formed in a portion of the glass substrate 41 that overlaps the foreign obstacle X1 and on a surface of the glass substrate 41 that is away from a liquid crystal layer 250. The second light blocking portion BL2 may be formed on the glass substrate 241 provided on the rear side by performing similar processes as the recess forming process and the second light blocking portion forming process described in the first embodiment. In the liquid crystal panel 211 according to the third embodiment, the second light blocking portion BL2 blocks light from the backlight unit and thus the light does not reach the foreign obstacle X1. Thus, the bright point defect is not recognized when the portion of the liquid crystal panel overlapping the foreign obstacle X1 is viewed from the front of the foreign obstacle X1 from a front side (light exit side) of the liquid crystal panel 211. Thus, according to the liquid crystal panel 211 of the third embodiment, the first light blocking portion BL1 and the second light blocking portion BL2 block light that causes the bright point defect. This achieves the liquid crystal panel 211 in which the bright point defect is effectively corrected.

### Fourth Embodiment

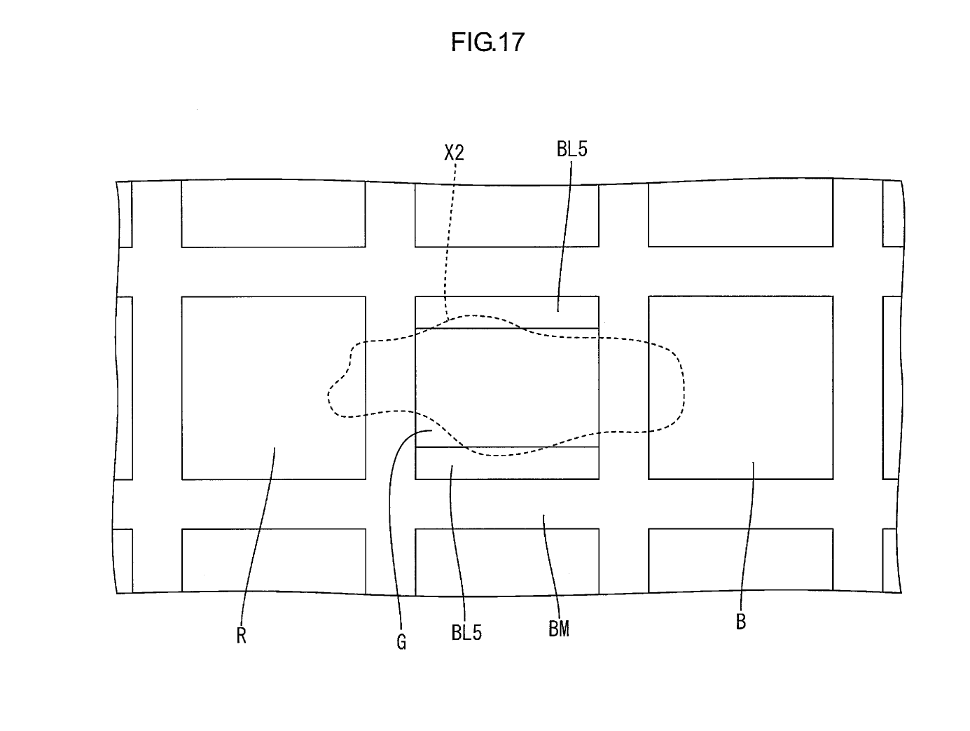

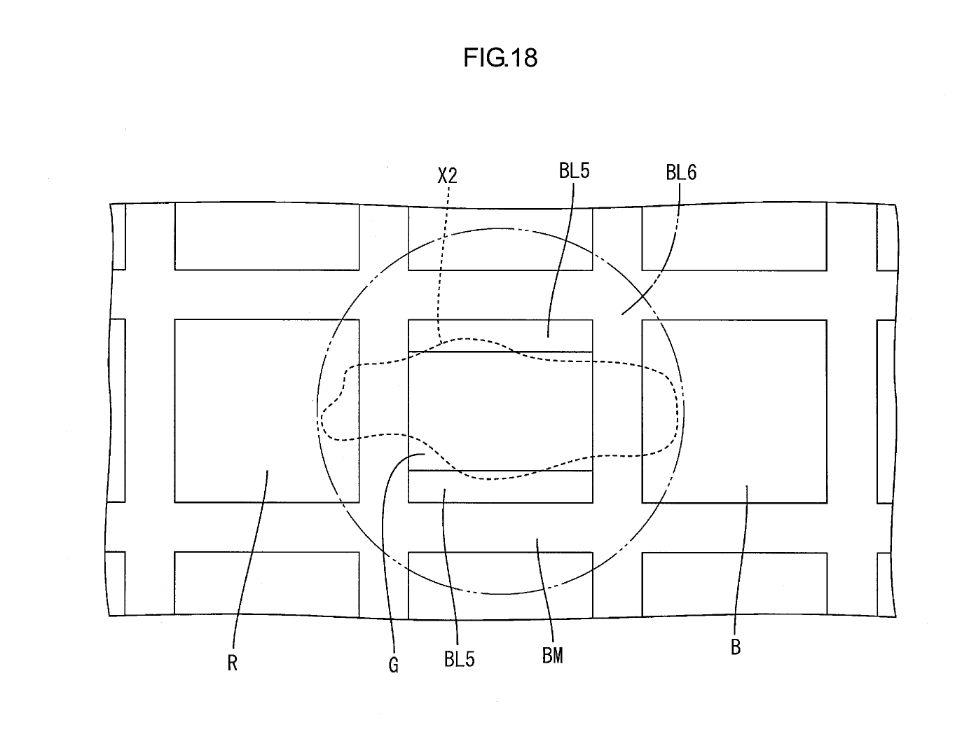

A fourth embodiment will be described with reference to the drawings. Each of FIG. 17 and FIG. 18 is a plan view of a part of the color filter adjacent to a colored section G in liquid crystal panel according to the fourth embodiment. The fourth embodiment differs from the first embodiment in an area in which a foreign substrate X2 is included and an area in which the first light blocking portion BL5 is formed. Other structures are same as those of the first embodiment, and thus configurations, functions, and effects similar to those of the first embodiment will not be explained.

In the liquid crystal panel according to the fourth embodiment, the liquid crystal layer includes a foreign obstacle X2, which may result in a bright point defect, in an area that overlaps the colored sections R, G, and B of the color filter, as illustrated in FIG. 17. In the first light blocking portion forming process, a laser irradiates only a part of the colored section G in the area that ranges over the colored sections R, G, B and surrounds the foreign obstacle X2. Accordingly, holes are formed in the areas that are irradiated with the laser. The laser then irradiates the black matrix BM adjacent to the areas that are irradiated with the laser and the holes are formed. This diffuses the black matrix BM inside the holes, and thus forms first light blocking portions BL5.

As illustrated in FIG. 18, a second light blocking portion BL6 is formed so as to cover an entire projection area of the foreign obstacle X2 in the recess forming process and the second light blocking portion forming process. The second light blocking portion BL6 has a substantially round shape. The second light blocking portion BL6 is formed inside the first light blocking portion BL5. According to the method of manufacturing the liquid crystal panel in the fourth embodiment, the first light blocking portion BL5 is only formed in an area overlapping the green colored section G. This simplifies the first light blocking portion forming process.

### Fifth Embodiment

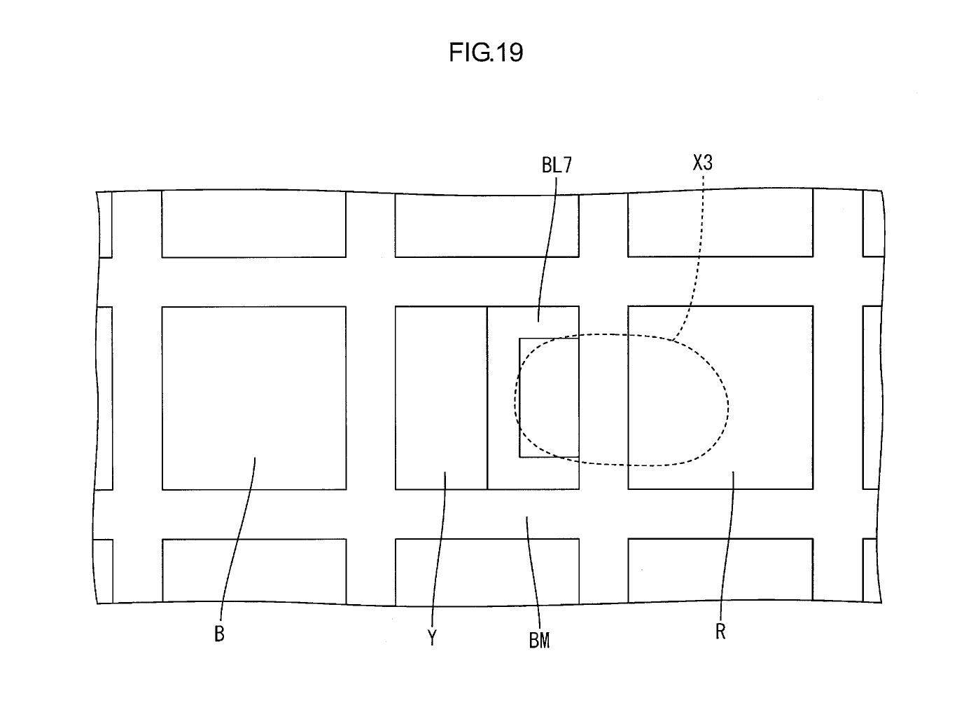

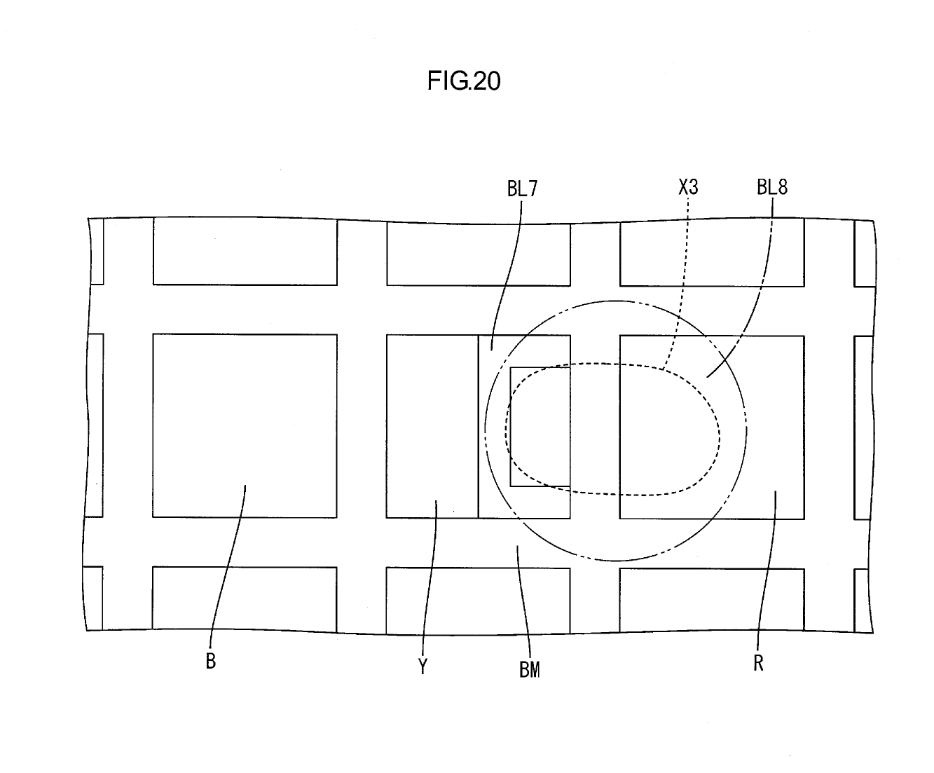

A fifth embodiment will be described with reference to the drawings. A liquid crystal panel according to the fifth embodiment is configured such that a colored section Y (yellow) is arranged between a colored section B and a colored section R of the color filter. Each of FIG. 19 and FIG. 20 is a plan view of apart of the color filter of the liquid crystal panel according to the fifth embodiment that is adjacent to the colored section Y. The fifth embodiment differs from the first embodiment in an area of the liquid crystal layer occupied by a foreign substrate X3 and an area occupied by of the first light blocking portion BL7. Other structures are same as those of the first embodiment, and thus configurations, functions, and effects similar to those of the first embodiment will not be explained.

In the liquid crystal panel according to the fourth embodiment, the liquid crystal layer includes the foreign obstacle X3 in a portion that overlaps the colored sections Y and R of the color filter, as illustrated in FIG. 19. The foreign obstacle X3 may cause a bright point defect. The laser irradiates a portion of an area surrounding the foreign obstacle X3 and ranging over the colored sections Y, R to form a hole. The laser irradiates the black matrix BM adjacent to the area that is irradiated with the laser. This diffuses the black matrix BM into the hole, and thus forms a first light blocking portion BL7.

As illustrated in FIG. 20, a second light blocking portion BL8 is formed so as to cover an entire projection area of the foreign obstacle X3 in the recess forming process and the second light blocking portion forming process. The second light blocking portion BL8 has a substantially round shape. The second light blocking portion BL8 is formed inside the first light blocking portion BL7. According to the method of manufacturing the liquid crystal panel in the fifth embodiment, the first light blocking portion BL7 is formed only in an area overlapping the yellow colored section Y. This simplifies the first light blocking portion forming process.

The above embodiments may be modified in the following forms.

(1) In the first embodiment, the second light blocking portion is formed after the first light blocking portion is formed. However, the order of forming the first and second light blocking portions is not limited thereto. The second light blocking portion may be formed prior to forming the first light blocking portion if the first light blocking portion can be formed while the second light blocking portion has been formed.

(2) In the above second embodiment, the direct method is used to carbonize a part of the color filter. However, the color filter may be carbonized in other methods.

(3) Positions of the first and second light blocking portions are not limited to the above embodiments, and may be suitably changed.

(4) In the above embodiments, the television device including the tuner is used. However, the technology can be applied to a display device without a tuner.

The embodiments of the present invention are explained in detail above for illustrative propose only, and it is to be understood that the claims are not limited by the forgoing description. The technology described in the claims includes the various modifications of the embodiments described above.

The technology components described in the description and the drawings are not required to be used in the combination described in the claims as originally filed. The technology components can show its technical utility when used either alone or in combination. In addition, the technology described in the above description and the drawings can achieve more than one object at the same time, and the technical utility of the technology can be recognized when the technology achieves one of the objects.

### EXPLANATION OF SYMBOLS

TV: television device, Ca, Cb: cabinet, T: tuner, S: stand, 10: liquid crystal display device, 11, 211: liquid crystal panel, 12: backlight unit 13: bezel, 14: chassis, 15: optical member, 16: frame, 17: cold cathode tube, 18: holder, 19: lamp holder, 20: lamp clip, 30, 40, 230, 240: board, 31, 41, 141, 231, 241: glass substrate, 42, 142, 242: color filter, 32, 232: TFT, 33, 233: pixel electrode, 34, 44, 234, 244: alignment film, 43, 243: counter electrode, 50: liquid crystal layer, BL1, BL3, BL5, BL7: first light blocking portion, BL2, BL6, BL8: second light blocking portion, BM: black matrix, H: hole, L: laser, X1, X2, X3: foreign obstacle.

1. A method of manufacturing a liquid crystal panel including a pair of substrates and a liquid crystal layer provided between the pair of the substrates, the method comprising:
detecting a bright point defect in the liquid crystal panel;
forming a first light blocking portion in one of the substrates and in at least a part of a bright point defect area of the substrate, the bright point defect area surrounding the bright point defect with a plan view;
forming a recess in a portion of one of the substrates so as to overlap the bright point defect, the recess being formed on a surface of the substrate that is opposite from a surface facing the liquid crystal layer; and
forming a second light blocking portion in the recess.

2. The method of manufacturing a liquid crystal panel according to claim 1, wherein in forming the first light blocking portion, the first light blocking portion is formed in a loop so as to surround the bright point defect with a plan view.

3. The method of manufacturing a liquid crystal panel according to claim 1, wherein in forming the first light blocking portion, the first light blocking portion is formed by blackening the part of the substrate.

4. The method of manufacturing a liquid crystal panel according to claim 3, wherein in forming the first light blocking portion, the part of the substrate is blackened by diffusing a black matrix to the part of the substrate.

5. The method of manufacturing a liquid crystal panel according to claim 3, wherein in forming the first light blocking portion, the part of the substrate is blackened by irradiating the part of the substrate with a laser and carbonizing the part of the substrate.

6. The method of manufacturing a liquid crystal panel according to claim 1, wherein in forming the first light blocking potion, the first light blocking portion is only formed in a portion of the bright point defect area surrounding the bright point defect with a plan view, the portion overlapping one of a yellow pixel and a green pixel.

7. The method of manufacturing a liquid crystal panel according to claim 1, wherein in forming the second light blocking portion, the second light blocking portion is formed such that a part of the second light blocking portion and a part of the first light blocking portion overlap each other.

8. The method of manufacturing a liquid crystal panel according to claim 1, wherein in forming the second light blocking portion, the second light blocking portion is formed by filling the recess with a light blocking material.

9. The method of manufacturing a liquid crystal panel according to claim 8, wherein in forming the second light blocking portion, the light blocking material is a black lacquer.

10. The method of manufacturing a liquid crystal panel according to claim 8, wherein in forming the second light blocking potion, the recess is filled with the light blocking material so as to be flattened at an opening surface of the recess.

11. The method of manufacturing a liquid crystal panel according to claim 1, wherein in forming the recess, the recess is formed by drilling a part of the substrate using a drill.

12. The method of manufacturing a liquid crystal panel according to claim 1, wherein in forming the recess, the recess is formed to have a depth greater than a half of a thickness of the substrate.

13. A liquid crystal panel comprising:
a pair of substrates;
a liquid crystal layer provided between the pair of substrates;
a first light blocking portion formed in one of the substrates, the first light blocking portion being formed in a part of an area that surrounds a bright point defect of the substrate with a plan view;
a recess formed in a portion of one of the substrates that overlaps the bright point defect, and the recess being formed on a surface of the one substrate opposite from a surface facing the liquid crystal layer; and
a second light blocking portion formed in the recess.

14. A liquid crystal display device comprising the liquid crystal panel according to claim 13.

15. A television device comprising the liquid crystal display device according to claim 14.
